(19) United States
(12) Patent Application Publication
(10) Pub. No.: US 2009/0013951 A1
(43) Pub. Date: Jan. 15, 2009

(54) CONTROL SYSTEM AND METHOD OF DELIVERING START-UP FUEL TO AN ENGINE

(75) Inventors: Hiroshi Nakata, Shibata-Gun (JP); Tsuyoshi Watanabe, Iwanuma-City (JP)

Correspondence Address: REISING, ETHINGTON, BARNES, KISSELLE, P.C., P O BOX 4390, TROY, MI, 48099-4390, US

(73) Assignee: Walbro Engine Management L.L.C., Tucson, AZ (US)

(21) Appl. No.: 12/170,099

(22) Filed: Jul. 9, 2008

(30) Foreign Application Priority Data
Jul. 11, 2007 (JP) 2007-181634

(51) Int. Cl. F02M 1/16

(52) U.S. Cl. 123/179.14

(57) ABSTRACT

A method and system that control delivery of start-up fuel to an engine, in one form includes clocking a first predetermined period of time. The method includes allowing start-up fuel to be supplied to the engine during at least some of the first predetermined period of time. The method also includes clocking a second predetermined period of time that comes after the first predetermined period of time. And the method includes not allowing start-up fuel to be supplied to the engine when the second predetermined period of time is clocking. In another form, the system includes a carburetor and a control unit.

### CROSS-REFERENCE TO RELATED APPLICATION

Applicants claim priority of Japanese Application, Ser. No. 2007-181634, filed Jul. 11, 2007.

### FIELD OF THE INVENTION

The present invention relates generally to fuel systems for internal combustion engines, and more particularly to controlling fuel delivery during start-up of the engines.

### BACKGROUND OF THE INVENTION

Two-stroke internal combustion engines—such as those used in chainsaws, brushcutters, and the like—are often equipped with carburetors for mixing and supplying air and fuel to the engine. Some carburetors have start-up systems that supply an additional amount of fuel to the engine when attempting to start the engine. But sometimes the additional fuel continues with repeated failed start attempts, causing the engine to flood. When this happens, an associated spark plug can become wetted or otherwise coated in fuel, and can be difficult to spark.

### SUMMARY OF THE INVENTION

One implementation of a presently preferred method of controlling fuel delivery to an engine when attempting to start-up the engine may include clocking, or measuring, a first predetermined period of time. The method may include allowing start-up fuel to be supplied to the engine during at least some of the first predetermined period of time. The method may also include clocking a second predetermined period of time that comes chronologically after the first predetermined period of time. And the method may include not allowing start-up fuel to be supplied to the engine when the second predetermined period of time is being clocked.

One implementation of a presently preferred system that controls delivery of start-up fuel to an engine may include a carburetor and a control unit. The carburetor can define a part of a start-up fuel supply passage that itself has a valve disposed therein. The control unit can selectively open the valve, and may have a first timer and a second timer. The first timer clocks, or measures, a first predetermined period of time during which the valve can open, and the second timer clocks a second predetermined period of time during which the valve is not open.

One implementation of a presently preferred start-up fuel delivery control unit used with an engine may include an ignition control circuit and a solenoid valve control circuit. The ignition control circuit receives a rotation voltage signal from a rotation sensor coil that is associated with the engine. The ignition control circuit determines the number of cranking revolutions that are performed during a single engine crank, and sends a solenoid valve drive signal only during a reference number of cranking revolutions which may be less than the total number of cranking revolutions during the single engine crank. The solenoid valve control circuit receives the solenoid valve drive signal and, depending on factors, sends a valve open drive signal to a solenoid valve which commands the solenoid valve to open.

### BRIEF DESCRIPTION OF THE DRAWINGS

The following detailed description of preferred embodiments and best mode will be set forth with reference to the accompanying drawings, in which:

FIG. 1 is a schematic of an engine having a carburetor and a control unit that controls the delivery of start-up fuel to the engine;

FIG. 2 is a schematic of the engine, the carburetor, and the control unit of FIG. 1, showing generally how they interact with each other;

FIG. 3 is a block diagram modeling parts of the control unit of FIG. 1;

FIG. 4 shows the timing associated with start-up fuel delivery to the engine of FIG. 1; and

FIG. 5 is a flow chart representing a process of controlling start-up fuel delivery to the engine of FIG. 1.

### DETAILED DESCRIPTION OF PREFERRED EMBODIMENTS

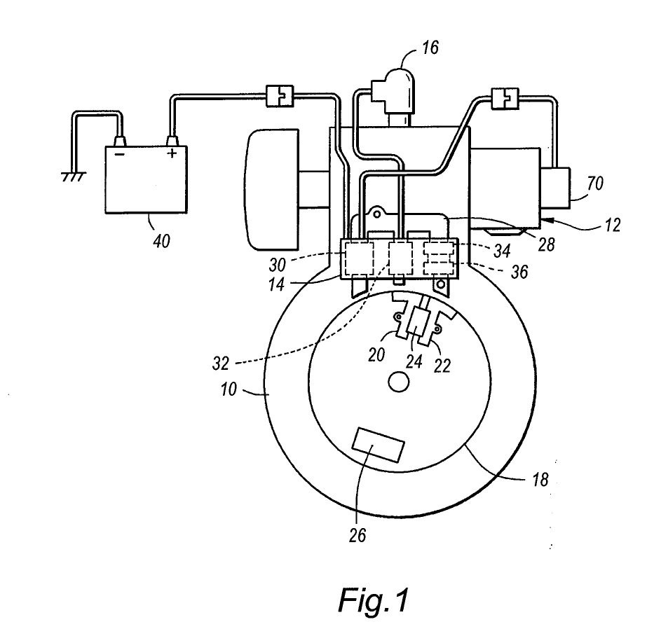

Referring in more detail to the drawings, FIGS. 1-5 show exemplary embodiments of a system and a method of controlling start-up fuel delivery to an engine 10 of a chain-saw, a brushcutter, or other suitable small engine application. Start-up or priming fuel can be an increased amount of fuel (as compared to the amount of fuel regularly supplied during normal operating parameters of the engine) supplied to the engine 10 while attempting to start the engine; for example, a “boost” of fuel. The system and method can reduce the likelihood of, or altogether prevent, engine flooding that may occur with repeated failed attempts at starting the engine and with the associated repeated start-up or priming fuel delivery. In general, the system may monitor a parameter of a start-up process and may allow start-up fuel delivery to the engine 10 only when the parameter satisfies a particular condition. As discussed below, one parameter may be time, and another parameter may be cranking revolutions or engine cranks. The system may include a carburetor 12 that helps deliver the start-up fuel to the engine 10, and a control unit 14 that manages the start-up fuel delivery.

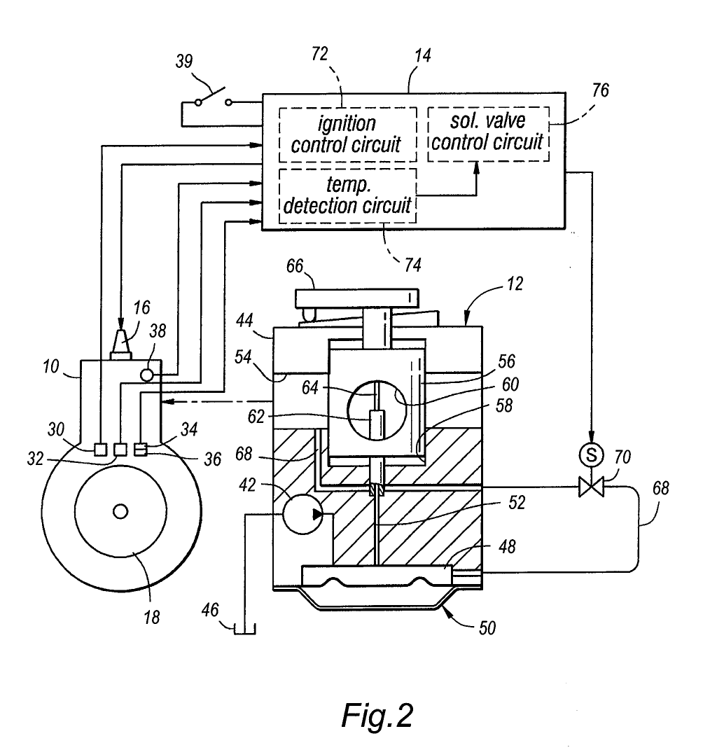

Referring to FIGS. 1 and 2, the engine 10 can be a two-stroke internal combustion engine that provides mechanical power to the particular small engine application. A spark plug 16 may be provided to generate a spark which ignites an air-fuel mixture in a combustion chamber of the engine 10. A flywheel 18 rotates about a shaft of the engine 10, and may have a first pole piece 20 mounted thereon, a second pole piece 22 mounted thereon, and a magnet 24 located between the pole pieces. The flywheel 18 may also have a weight 26 located circumferentially opposite the first and second pole pieces 20, 22 for balancing the flywheel. An E-shaped camstack or bracket 28 may be mounted adjacent the flywheel 18 so that one or more coils located thereon can communicate with an electric or magnetic field emitted by the first and second pole pieces 20, 22 and the magnet 24. For example, the E-shaped bracket 28 may carry a generator coil 30 that gives charge voltage to a power source, an ignition coil 32, a rotation sensor 34, and a capacitive discharge ignition (CDI) exciter coil 36.

The rotation sensor coil 34 detects the presence of the first and second pole pieces 20, 22 and the magnet 24 as they rotate past the rotation sensor coil. The rotation sensor coil 34 sends a corresponding rotation voltage signal. A temperature sensor 38 may be located on the engine 10 and may have a thermister that detects the temperature of the engine (Te) or the temperature adjacent to the engine. A start switch 39 may be electrically connected to the control unit 14, and may be used with an automatic electric starter motor or may be used with a manual starter such as a recoil starter. A power source such as a battery 40 may be used for storing and supplying electrical power to parts of the carburetor 12, parts of the control unit 14, and parts of the engine 10.

The carburetor 12 mixes and supplies an air-fuel mixture to the engine 10 and helps deliver start-up fuel to the engine. In the example shown in FIG. 2, a fuel pump 42 may be carried by a lower part of the body 44 of the carburetor 12 and may draw fuel from an external fuel tank 46. The fuel pump 42 may deliver the fuel into a fuel pressure regulating chamber 48 that is defined in a diaphragm fuel adjusting mechanism 50. The body 44 may define a primary fuel supply passage 52 extending from the fuel pressure regulating chamber 48. The primary fuel supply passage 52 may supply fuel to the engine 10 at least during normal operation of the engine. An intake bore 54 delivers an air-fuel mixture that flows through a rotary throttle valve 56 to the engine 10. The throttle valve 56 extends across the intake bore 54, is held in a cylindrical support chamber 58, is rotatable about an axis of the cylindrical support chamber, and is linearly moveable in a direction of the axis. The throttle valve 56 defines a mixture passage 60 that extends through the throttle valve and is increasingly aligned with the intake bore 54 as the throttle valve moves from its idle position towards its wide open position. A fuel nozzle 62 may extend in the mixture passage 60 and may communicate with the fuel pressure regulating chamber 48 through the primary fuel supply passage 52. The fuel nozzle 62 receives a fuel metering needle valve 64 which also extends into the mixture passage 60 and may extend into the fuel nozzle.

A lever 66 may be attached to an end of the throttle valve 56, and is itself attached to a throttle cable (not shown). The lever 66 may have a camming engagement with the opposing end surface of the body 44, so that the lever moves axially as it is turned, and this in turn causes an axial movement of the throttle valve 56. Such axial movement may adjust the fuel metering valve 64 in and out of the fuel nozzle 62 to control fuel flow out of the fuel nozzle whereupon the fuel is mixed with air in the mixture passage 60 and the air-fuel mixture flows through the intake bore 54 and to the engine 10. Though shown and described as having the above construction, arrangement, and operation, the carburetor 12 can be of other types including, but not limited to, a butterfly valve type, slide valve type, and a float bowl type. For example, the throttle valve 56 can include a throttle valve, a choke valve, or a combination of both. In this regard, skilled artisans will know the general construction, arrangement, and operation of these types of carburetors including that described so that a more complete description will not be given here.

As mentioned, the carburetor 12 may be constructed to supply an increased amount of fuel when attempting to start the engine 10. For example, a start-up fuel supply passage 68 may communicate the fuel pressure regulating chamber 48 with the intake bore 54. The start-up fuel supply passage 68 may be partly defined in the body 44 to deliver supplementary fuel directly to the intake bore 54 downstream of the throttle valve 56, and separate from the primary fuel supply passage 52. A valve, such as a solenoid valve 70, may be disposed in the start-up fuel supply passage 68 to selectively open and close the start-up fuel supply passage. In this way, the solenoid valve 70 may control the timing of the start-up fuel delivery The start-up fuel supply passage 68 may have other arrangements than that shown; for example, the start-up fuel supply passage may communicate between the fuel pressure regulating chamber 48 and a fuel reservoir located adjacent the cylindrical support chamber 58.

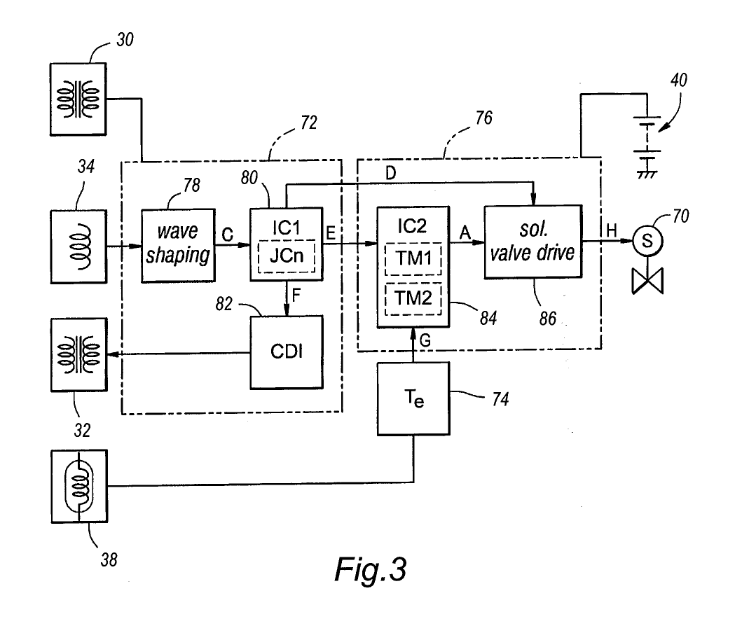

The control unit 14 manages and instructs the start-up fuel delivery through the carburetor 12 and to the engine 10 according to one or more conditions of the engine and of the start-up process or start-up attempt. For example, one condition may be the temperature of the engine 10, and another condition may be the time lapsed during repeated failed attempts at starting the engine. The control unit 14 may execute a program that is loaded onto a computer readable medium. Referring to FIGS. 2 and 3, one example of the control unit 14 may include an ignition control circuit 72, a temperature detection circuit 74, and a solenoid valve control circuit 76.

The ignition control circuit 72 may assist starting the engine 10 by, among other things, providing electrical current to the spark plug 16. In the example shown, the ignition control circuit 72 may be electrically coupled to the generator coil 30, the rotation sensor coil 34, and the ignition coil 32. For example, the ignition control circuit 72 may be powered by the generator coil 30 whereby the ignition control circuit would only operate when the generator coil is feeding power to it such as when the engine 10 is running. Here, the ignition control circuit 72 could also reset when the engine 10 is turned off. Referring to FIG. 3, the ignition control circuit 72 may include a wave shaping circuit 78, a first ignition control circuit (IC1) 80, and a capacitive discharge ignition (CDI) circuit 82.

The wave shaping circuit 78 can shape, or otherwise modify, the voltage signal coming from the rotation sensor coil 34 into a pulse signal, such as a rotation pulse signal C transmitted to the first ignition control circuit 80. The rotation pulse signal C results from a single crank of the engine 10 and a resulting number of cranking revolutions Nc (engine rotations) that, in this example, may produce five distinct pulses. The first ignition control circuit 80 receives the rotation pulse signal C, and may convert and internally accumulate only the first three (reference number of cranking revolutions Nr) of the five distinct pulses. The first ignition control circuit 80 may generate a solenoid valve drive signal D from the first three pulses, and may send the solenoid valve drive signal to the solenoid valve control circuit 76. The reference number of cranking revolutions Nr may be more or less than 3, as desired.

The first ignition control circuit 80 may also send a signal E to another part of the solenoid valve control circuit 76; the signal E corresponds to the rotation pulse signal C. The first ignition control circuit 80 may further send a signal F to the CDI circuit 82. The first ignition control circuit 80 may have a rotational speed determining circuit JCn that determines the rotational speed of the engine 10 from the detections made by the rotation sensor coil 34, and then determines if the rotational speed is greater than a reference rotational speed. The reference rotational speed may represent a rotational speed of an example engine that has started and is running. If the engine speed is greater than the reference speed, the first ignition control circuit 80 does not generate the solenoid valve drive signal D. The CDI circuit 82 receives the signal F, generates a corresponding signal, and sends the corresponding signal to the ignition coil 32. The ignition coil 32 in turn fires the spark plug 16.

The temperature detection circuit 74 compares and determines if the temperature of the engine (Te) is above or below a reference temperature (Tr). The reference temperature may represent a temperature above which the engine 10 can be started or operated without additional start-up fuel, such as when the engine has been operating for an extended period of time or when the engine successfully and initially begins to operate. The temperature detection circuit 74 receives a signal from the temperature sensor 38, and processes and converts the signal into a temperature detection signal G. The temperature detection signal G is then sent to the solenoid valve control circuit 76 for processing.

The solenoid valve control circuit 76 may, depending on certain circumstances, govern the actuation of the solenoid valve 70. Put differently, the solenoid valve control circuit 76 may control the ON\OFF state (e.g., opening and closing) of the solenoid valve 70. In the example shown in FIG. 3, the solenoid valve control circuit 76 may communicate in various ways with the ignition control circuit 72 and the temperature detection circuit 74. The solenoid valve control circuit 76 may include a second ignition control circuit (IC2) 84 and a solenoid valve drive circuit 86.

The second ignition control circuit 84 may, depending on certain conditions (e.g., time), generate a valve open signal A and send it to the solenoid valve drive circuit 86. The second ignition control circuit 84 may also receive the signal E, and may receive the temperature detection signal G from the temperature detection circuit 74. In the example shown in FIG. 3, the second ignition control circuit 84 may include a first timer TM1 and a second timer TM2.

The first timer TM1 may initially clock a first predetermined period of time (T1) after receiving the signal E. The first predetermined period of time may be a fixed time that is based on a period of time that a typical user waits before attempting to re-crank the engine 10 after an initial crank and attempted start-up fails. The first predetermined period of time can be determined by surveying or otherwise observing users and may be known by skilled artisans. In one implementation, the second ignition control circuit 84 only sends the valve open signal A during the first predetermined period of time. The second timer TM2 may clock a second predetermined period of time (T2) after the first predetermined period of time expires. The second predetermined period of time may be a fixed time that is based on a period of time required to remedy a wetted sparkplug (e.g., when the wetted fuel evaporates), or can be another desired period of time. During the second predetermined period of time, the first predetermined period of time is not clocked and the valve open signal A is not generated. After the second predetermined period of time expires and under certain conditions, the first predetermined period of time may begin clocking again.

The solenoid valve drive circuit 86 may, depending on certain circumstances, send a valve open drive signal H to the solenoid valve 70 in order to command the solenoid valve to open. For example, when the solenoid valve drive circuit 86 receives both the valve open signal A and the solenoid valve drive signal D, the solenoid valve drive circuit performs an AND logical sum and, if the condition is satisfied, (e.g., simultaneously receiving both signals A and D) sends the valve open drive signal H; otherwise, the solenoid valve drive circuit may send a valve close drive signal to the solenoid valve 70, or may not send a signal at all, and the solenoid valve is closed. The solenoid valve drive circuit 86 may be powered by the battery 40, or by power generated from cranking the engine 10.

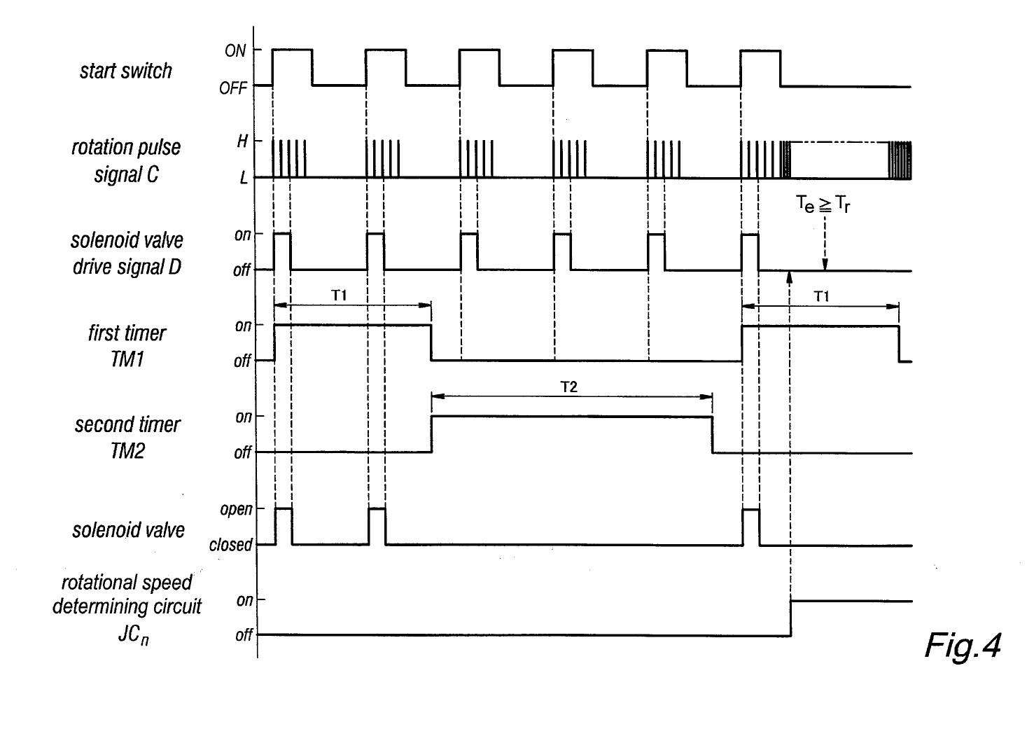

FIG. 4 shows the timing associated with various functioning of the control unit 14 and the solenoid valve 70. The start switch 39 may be activated ON during a single engine crank, and is otherwise OFF. A single engine crank also rotates the flywheel 18, which in turn generates the rotation voltage signal. The rotation pulse signal C is thus produced and may be received by the first ignition control circuit 80, which may then generate the solenoid valve drive signal D during the first three pulses of the engine crank. The first ignition control circuit 80 may also generate the signal E to the second ignition control circuit 84, and the first timer TM1 may in turn begin clocking the first predetermined period of time. The second ignition control circuit 84 may send the valve open signal A during the first predetermined period of time. The solenoid valve drive circuit 86 may then perform the AND logical sum, and if the condition is met, send the valve open drive signal H which commands the solenoid valve 70 to open.

The second timer TM2 may begin clocking the second predetermined period of time after the first predetermined period of time expires. The valve open signal A is not generated during the second predetermined period of time, and thus the AND logical sum is not satisfied and the solenoid valve 70 is not commanded to open. Consequently, start-up fuel is not delivered to the engine 10 during the second predetermined period of time, and engine flooding may thus be limited or altogether prevented with repeated failed start-up attempts during the second predetermined period of time. As described, the solenoid valve 70 may be opened during the first predetermined period of time, allowing fuel to be delivered to the engine 10 during the first predetermined period of time. This does not mean that fuel is necessarily delivered to the engine 10 during the first predetermined period of time, only that fuel can be supplied to the engine if the conditions are satisfied.

If the engine 10 is not started during the second predetermined period of time, the first predetermined period of time may begin again and the valve open signal A is again generated, allowing delivery of start-up fuel to the engine. For example, the first predetermined period of time begins again when the second ignition control circuit 84 receives another signal E, and the solenoid valve 70 may be commanded open under the same conditions as described above. If the engine 10 is successfully started during the first predetermined period of time as shown in FIG. 4, the rotational speed determining circuit JCn may prevent the first ignition control circuit 80 from generating the solenoid valve drive signal D, so that start-up fuel is no longer delivered to the engine.

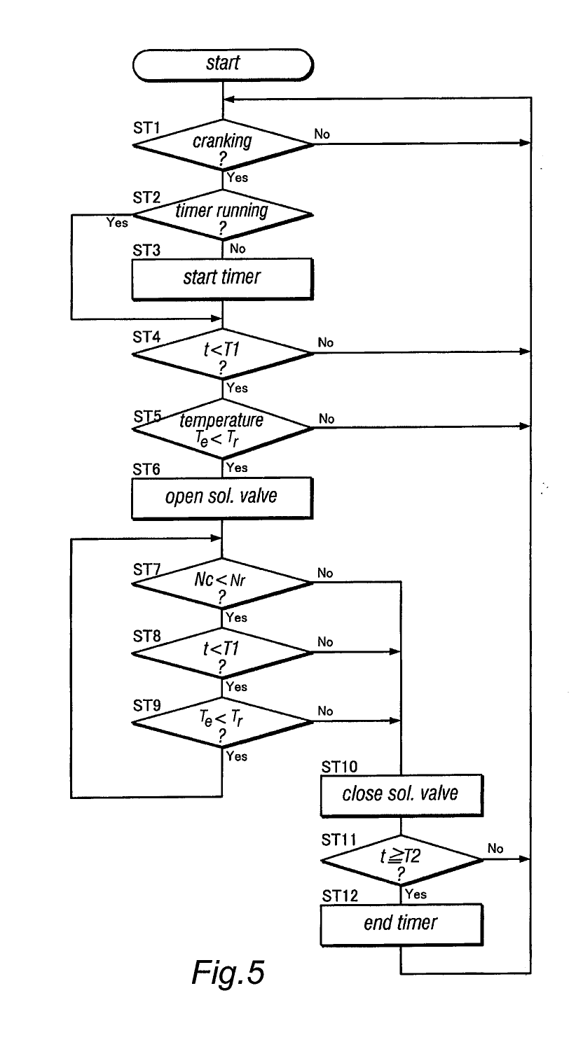

FIG. 5 shows a flow chart representing an example process or program flow that may be used to control the delivery of start-up fuel to the engine 10. This process may be executed by parts of the control unit 14. In a step ST1, it is determined if the engine 10 is being cranked. One way of doing so is detecting the presence or absence of the rotation voltage signal or the rotation pulse signal C. If the engine 10 is being cranked, the process advances to a step ST2. If the engine 10 is not being cranked, on the other hand, the process returns to the step ST1. One example of detecting an absence of the rotation pulse signal C may be to allow a predetermined period of time in which to detect the presence of the rotation pulse signal.

In the step ST2, it is determined if either the first timer TM1 or the second timer TM2 is running. If not, the process advances to a step ST3 where the first timer TM1 or the second timer TM2 may begin running. In this step, the first timer TM1 may start clocking, but the second timer TM2 may not start clocking and instead is placed in a standby condition. After the step ST3, or if the first timer TM1 or the second timer TM2 is running, the process advances to a step ST4 where it is determined if a time (t) clocked by the first timer TM1 is less than the first predetermined period of time. If the time is greater than or equal to the first predetermined period of time, the process returns to the step ST1. If, on the other hand, the time is less than the first predetermined period of time, the process advances to a step ST5.

In the step ST5, it is determined if the temperature of the engine (Te) is below the reference temperature (Tr). If so (meaning that the engine may be cold), the process advances to a step ST6. If not (meaning that the engine may be hot), the process returns to the step ST1. In the step ST6, the solenoid valve 70 is commanded to open, and the process advances to a step ST7. In the step ST7, it is determined if the number of cranking revolutions Nc is less than the reference number of cranking revolutions Nr. If so, the process advances to a step ST8. In the step ST8, it is determined if the time (t) of the first timer TM1 is less than the first predetermined period of time (T1). If so, the process advances to a step ST9. In the step ST9, it is determined if the temperature of the engine (Te) is less than the reference temperature (Tr). If so, the process returns to the step ST7.

In the steps ST7, ST8, and ST9, if the conditions of the respective steps are not satisfied, the process advances to a step ST10. In the step ST10, the solenoid valve 70 is not commanded to open or is commanded to close, and the process advances to a step ST11. In the step ST11, it is determined if the time (t) clocked by the second timer TM2 is greater than or equal to the second predetermined period of time (T2). If so, the process returns to the step ST1; if not, the process advances to a step ST12. In the step ST12, the first timer TM1 and the second timer TM2 are stopped from running, and the process returns to the step ST1.

Accordingly, additional fuel to assist starting the engine 10 is only provided during the first predetermined period of time (T1) which can be set to correspond to a desired limit number of cranking revolutions Nc. If the engine 10 does not start during the limited number of attempts, addition fuel is not provided during further attempts to start the engine (i.e., during further cranking revolutions Nc) until the second predetermined period of time (T2) expires. This prevents too much start-up fuel from being provided to the engine 10, which could adversely affect or prevent engine operation.

While the forms of the invention herein disclosed constitute presently preferred embodiments, many others are possible. For example, instead of clocking the first predetermined period of time in which start-up fuel may be provided, the system may count cranking revolutions Nc during a single crank of the engine 10, or may simply count the total number of single cranks, and provide start-up fuel only during a desired number of revolutions or cranks. The second predetermined period of time may still be clocked to control resetting the counting of revolutions or cranks. The second predetermined period of time may begin upon the initial engine crank and may terminate after a predetermined time has elapsed, or any other suitable counting of time or other event may be used to control whether start-up fuel can be provided to the engine 10. It is not intended herein to mention all the possible equivalent forms or ramifications of the invention. It is, understood that the terms used herein are merely descriptive, rather than limiting, and that various changes may be made without departing from the spirit or scope of the invention.

1. A method of controlling fuel delivery to an engine at start-up, the method comprising:
clocking a first predetermined period of time;
allowing start-up fuel to be supplied to the engine during at least some of the first predetermined period of time;
clocking a second predetermined period of time after the first predetermined period of time has ended; and
not allowing start-up fuel to be supplied to the engine during the second predetermined period of time.

2. The method of claim 1 further comprising detecting an initial cranking rotation of the engine, and then beginning to clock the first predetermined period of time.

3. The method of claim 1 further comprising detecting the temperature of the engine, comparing the detected temperature to a reference temperature, and not allowing start-up fuel to be supplied to the engine if the detected temperature is greater than the reference temperature.

4. The method of claim 1 further comprising determining the rotational speed of the engine, comparing the determined rotational speed to a reference rotational speed, and not allowing start-up fuel to be supplied to the engine if the determined rotational speed is greater than the reference rotational speed.

5. The method of claim 1 further comprising detecting the number of cranking revolutions performed during a single engine crank, and allowing start-up fuel to be supplied to the engine only during a reference number of cranking revolutions which is less than the total number of cranking revolutions during the single engine crank.

6. The method of claim 1 further comprising producing a signal during the first predetermined period of time which allows start-up fuel to be supplied to the engine, and not producing the signal during the second predetermined period of time which does not allow start-up fuel to be supplied to the engine.

7. A system that controls delivery of start-up fuel to an engine, the system comprising:
a carburetor defining a start-up fuel supply passage having a valve disposed therein; and
a control unit selectively opening the valve, the control unit having a first timer that clocks a first predetermined period of time during which the valve can open, and the control unit having a second timer that clocks a second predetermined period of time during which the valve is closed.

8. The system of claim 7 wherein the control unit has an ignition control circuit that receives a rotation voltage signal and then sends a valve drive signal to a valve drive circuit in order to allow the valve to open.

9. The system of claim 8 wherein, during the first predetermined period of time, a valve open signal is sent to the valve drive circuit that, when received with the valve drive signal, sends a valve open drive signal to open the valve.

10. The system of claim 7 wherein the control unit has an ignition control circuit that determines the number of cranking revolutions performed during a single engine crank, and that sends a valve drive signal only during a reference number of cranking revolutions which is less than the total number of cranking revolutions during the single engine crank, in order to allow the valve to open.

11. The system of claim 7 wherein the control unit has an ignition control circuit that determines the rotational speed of the engine, and if the determined rotational speed is greater than a reference rotational speed, the valve is not allowed to open.

12. The system of claim 7 wherein the control unit has a temperature detection circuit that detects the temperature of the engine, and if the detected temperature is greater than a reference temperature, the valve is not allowed to open.

13. The system of claim 7 wherein the control unit has an ignition control circuit that receives a rotation pulse signal generated from an initial cranking revolution of the engine, and that sends a corresponding signal to begin clocking the first timer.

14. The system of claim 7 wherein the second timer begins clocking immediately after the first timer ends clocking.

15. A start-up fuel delivery control unit for an engine, the control unit comprising:
an ignition control circuit receiving a rotation voltage signal from a rotation sensor coil of the engine, determining the number of cranking revolutions performed during a single engine crank, and sending a solenoid valve drive signal only during a reference number of cranking revolutions which is less than the total number of cranking revolutions during the single engine crank; and
a solenoid valve control circuit receiving the solenoid valve drive signal and selectively sending a valve open drive signal to a solenoid valve which opens the solenoid valve.

16. The control unit of claim 15 further comprising a temperature detection circuit that detects the temperature of the engine and compares the detected temperature to a reference temperature.

17. The control unit of claim 15 wherein the ignition control circuit includes a wave shaping circuit that receives the rotation voltage signal, shapes the rotation voltage signal, and sends a rotation pulse signal.

18. The control unit of claim 17 wherein the ignition control circuit includes a first ignition control circuit that receives the rotation pulse signal and sends the solenoid valve drive signal.

19. The control unit of claim 18 wherein the solenoid valve control circuit includes a second ignition control circuit having a first timer that clocks a first predetermined period of time, and having a second timer that clocks a second predetermined period of time.

20. The control unit of claim 19 wherein the solenoid valve control circuit includes a solenoid valve drive circuit that receives the solenoid valve drive signal and only sends the valve open drive signal to the solenoid valve during the first predetermined period of time.

21. A method of controlling fuel delivery to an engine at start-up, the method comprising:
monitoring at least one parameter of the engine;
comparing the at least one parameter to a reference parameter; and
allowing start-up fuel to be supplied to the engine only when a condition between the at least one parameter and the reference parameter is satisfied.

22. The method of claim 21 wherein monitoring at least one parameter comprises clocking a first predetermined period of time and a second predetermined period of time, and wherein allowing start-up fuel to be supplied comprises allowing start-up fuel to be supplied during at least some of the first predetermined period of time and not allowing start-up fuel to be supplied during the second predetermined period of time.

23. The method of claim 21 wherein monitoring at least one parameter comprises detecting a number of cranking revolutions or a number of engine cranks, and wherein allowing start-up fuel to be supplied comprises allowing start-up fuel to be supplied to the engine only during a reference number of cranking revolutions or during a reference number of engine cranks.
